(19) United States
(12) Patent Application Publication
(10) Pub. No.: US 2005/0123860 A1
(43) Pub. Date: Jun. 9, 2005

(54) Dielectric with fluorescent material

(76) Inventors: Paul Koning, Chandler, AZ (US); Boyd Coomer, Scottsdale, AZ (US); Robert Edgeworth, Phoenix, AZ (US)

Correspondence Address: Michael A. Bernadicou;BLAKELY, SOKOLOFF, TAYLOR & ZAFMAN LLP, Seventh Floor, 12400 Wilshire Boulevard, Los Angeles, CA, 90025, US

(21) Appl. No.: 10/727,708

(22) Filed: Dec. 3, 2003

(51) Int. Cl. G03C 5/00

(52) U.S. Cl. 430/320

(57) ABSTRACT

The invention provides fluorescent material in dielectric material. This allows detection of whether an imprinting tool has properly formed features in the dielectric material, and allows detection of when some dielectric material has stuck to the imprinting tool.

### BACKGROUND OF THE INVENTION

Substrates have layers of dielectric material that separate conductors at different levels of the substrate. Micro vias pass through layers of dielectric material to electrically connect conductors at different levels. Imprinting tools can be used to help form these vias. A male patterned imprinting tool is pressed through a dielectric layer to make contact with the conductor under the dielectric layer. This forms a trench in the dielectric layer that, when filled with conductive material, creates a via.

If the imprinting process leaves some residual dielectric at the bottom of the trench, the conductive material that will fill the trench may not make contact with the underlying conductor. This may prevent the substrate from functioning properly. Additionally, dielectric material from the substrate sometimes sticks to the imprinting tool. This degrades quality of features subsequently formed by the imprinting tool.

### BRIEF DESCRIPTION OF THE DRAWINGS

FIG. 1 is a side cross sectional view of a substrate according to one embodiment of the present invention.

FIG. 2 is a side cross sectional view that illustrates a portion of how the via of the substrate may be formed.

FIG. 3a is a side cross sectional view that illustrates one example of a result of an imprinting process.

FIG. 3b is a side cross sectional view that illustrates another example of a result of an imprinting process.

FIG. 4 is a schematic view of an embodiment of a detection device for detecting whether there is material at the bottom of the trench formed by the imprinting tool.

FIG. 5 is a side cross sectional view that illustrates the second conductor and via that may be formed on the first dielectric layer.

FIG. 6 is a schematic diagram of a computer system according to one embodiment of the present invention.

FIG. 7 is a schematic view of an embodiment of a detection device for detecting whether there is material from the first dielectric layer stuck on the imprinting tool.

### DETAILED DESCRIPTION

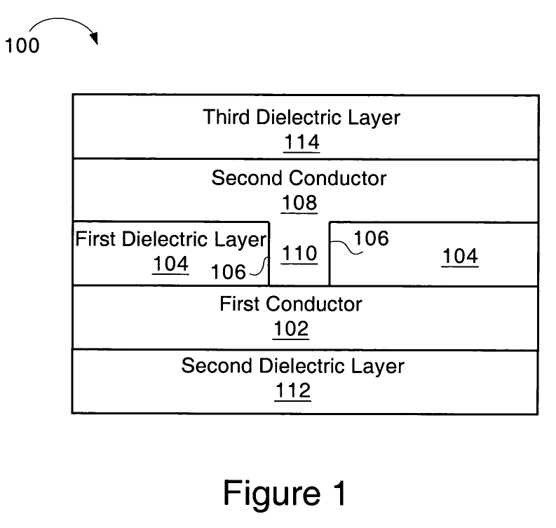

FIG. 1 is a side cross sectional view of a substrate 100 according to one embodiment of the present invention. The substrate 100 may include a first conductor 102. The first conductor 102 may be a conductive trace, a conductive core, or another conductor. In some embodiments, the first conductor 102 may comprise copper, aluminum, or other materials.

There may be a first dielectric layer 104 that covers at least part of the first conductor 102. In an embodiment, the first dielectric layer 104 may have a thickness in a range from about 10 microns to about 70 microns. In another embodiment, the first dielectric layer 104 may have a thickness in a range from about 20 microns to about 50 microns. The first dielectric layer 104 may comprise an insulating material, such as an epoxy, an epoxy blend, BT (a blend of Bismaleimide and Triazine resins), polyimide, a polyimide blend, LCP (Liquid Crystal Polymer, aromatic copolyesters), PPO (polyphenylene oxide), Cyanate Ester, PPS (polyphenylene sulfide), or another material or combination of materials. The first dielectric layer 104 may also comprise a fluorescent material. In an embodiment, the fluorescent material may comprise less than about 10 percent of the dielectric material of the first dielectric layer 104. In another embodiment, the fluorescent material may comprise less than about 2 percent of the dielectric material of the first dielectric layer 104. The fluorescent material may be a material that absorbs electromagnetic radiation in a first range of wavelengths and in response emits electromagnetic radiation in a second range of wavelengths. The first range may include all or part of the range of wavelengths that make up ultraviolet light in an embodiment. The second range may include all or part of the range of wavelengths that make up visible light in an embodiment. Ultraviolet light may have a wavelength in a range of about 10 nanometers to about 400 nanometers. Visible light may have a wavelength in a range from about 400 nanometers to about 700 nanometers.

The first dielectric layer 104 may have side walls 106 that extend from the top to the bottom of the first dielectric layer 104 to define boundaries of a via 110. These side walls 106 may be vertical, as illustrated in FIG. 1, may be slanted so that the via 110 is wider at the top than at the bottom, or may have another configuration.

There may be a second conductor 108 on the first dielectric layer 104. The second conductor 108 may cover all or part of the first dielectric layer 104. The second conductor 108 may be a conductive trace, a conductive core, or another conductor. In some embodiments, the second conductor 108 may comprise copper, aluminum, or other materials. The substrate 100 may include a via 110. The via 110 may comprise a conductive material that electrically connects the first conductor 102 to the second conductor 108. In some embodiments, the via 110 may comprise copper, aluminum, or other materials. The via 110 may simply be part of the same piece of conductive material that comprises the second conductor 108, and may have been formed at the same time as the second conductor 108 in an embodiment. In another embodiment, the via 110 may be formed separately from the second conductor 108 and have an electrical connection with the second conductor 108.

The substrate 100 may include second and/or third dielectric layers 112, 114 as well. For example, the first conductor 102 may partially or completely cover the second dielectric layer 112. The third dielectric layer 114 may cover the second conductor 108. Additionally, the substrate 100 may include numerous other structures or layers, such as additional vias, additional conductors, additional dielectric layers, and other features.

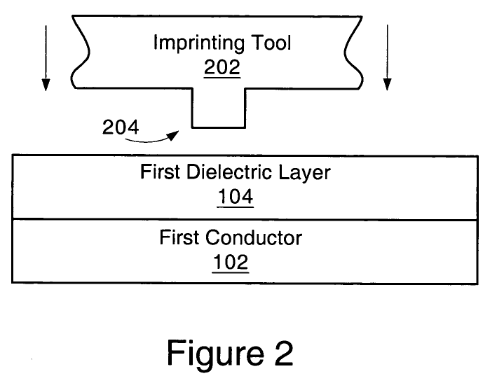

FIG. 2 is a side cross sectional view that illustrates a portion of how the via 110 of the substrate 100 may be formed according to one embodiment of the present invention. An imprinting tool 202 with one or more features 204 may be pressed into the first dielectric layer 104 to transfer the features 204 on the imprinting tool 202 to the first dielectric layer 104. Note that for simplicity, only the first dielectric layer 104 and the first conductor 102 are illustrated in FIG. 2. Other parts (not shown) of the substrate 100 may also be connected to the first dielectric layer 104 and first conductor 102 at this point. The one or more features 204 of the imprinting tool 202 may be part of a male pattern that imprints the first dielectric layer 104 with various depressions to allow later formation of lines, traces, vias, or other features through a process such as electroplating or another process. The first dielectric layer 104 on the first conductor 102 may be softened at the time it contacts the imprinting tool 202. In an embodiment, the first dielectric layer 104 may comprise epoxy, and may be softened with heat, such as being raised to a temperature in a range of about 150 degrees Celsius to about 160 degrees Celsius. In other embodiments where the first dielectric layer 104 may comprise different materials, different temperatures may be used to soften the first dielectric layer 104, or different methods may be used to soften the first dielectric layer 104.

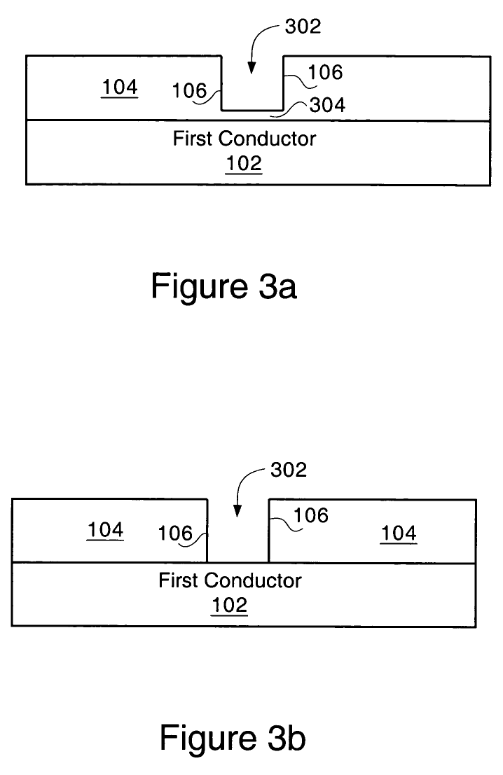

FIG. 3a is a side cross sectional view that illustrates one example of a result of an imprinting process such as described with respect to FIG. 2. Pressing the imprinting tool 202 into the first dielectric layer 104 has resulted in formation of a trench 302 in the first dielectric layer 104. The trench 302 is defined by sidewalls 106 of the first dielectric layer 104 and may have various shapes, as discussed above with respect to FIG. 1. In the example illustrated in FIG. 3, the male feature 204 of the imprinting tool 202 has not reached all the way through the first dielectric layer 104 to the first conductor 102. Some dielectric material 304 of the first dielectric layer 104 remains at the bottom of the trench 302. Such remaining material 304 may prevent successful formation of a via 110 that electrically connects the first conductor 102 with the second conductor 108. The material 304 may be in a very thin layer, such as a micrometer or less. This makes it difficult to detect since it is substantially optically transparent, and so thin that mechanical probes may penetrate it to reach the first conductor 102 to result in a false reading that the material 304 is not there.

FIG. 3b is a side cross sectional view that illustrates another example of a result of an imprinting process such as described with respect to FIG. 2. Like the example of FIG. 3a, in the example of FIG. 3b, pressing the imprinting tool 202 into the first dielectric layer 104 has resulted in formation of a trench 302 in the first dielectric layer 104. The trench 302 is defined by sidewalls 106 of the first dielectric layer 104 and may have various shapes, as discussed above with respect to FIG. 1. In the example illustrated in FIG. 3b, the male feature 204 of the imprinting tool 202 has reached substantially all the way through the first dielectric layer 104 to the first conductor 102. Substantially no dielectric material of the first dielectric layer 104 remains at the bottom of the trench 302. This allows a via 110 to properly electrically connect the first conductor 102 with the second conductor 108.

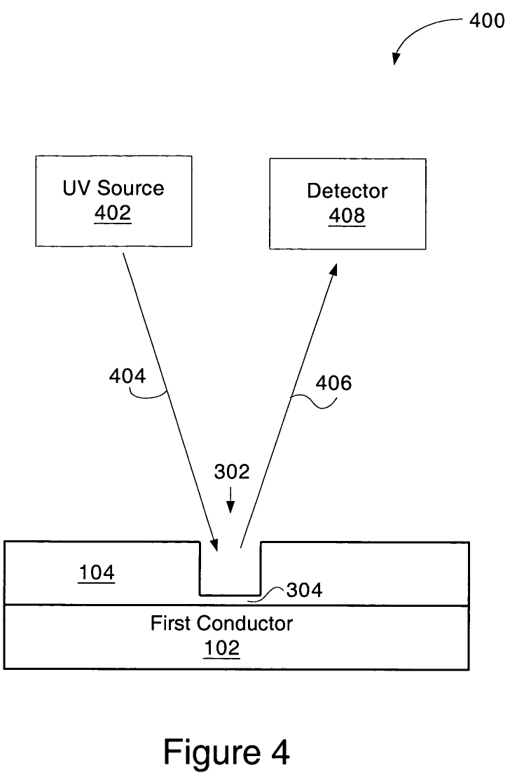

FIG. 4 is a schematic view of an embodiment of a detection device 400 for detecting whether there is material 304 at the bottom of the trench 302 formed by the imprinting tool 202. A radiation source, such as UV source 402 may be used to generate radiation 404 directed at the trench 302 in the first dielectric layer 104. The radiation 404 may be in the first range of wavelengths that is absorbed by the fluorescent material in the first dielectric layer 104. In response to radiation 404 striking the material 304, the fluorescent material within any material 304 remaining at the bottom of the trench 302 may emit electromagnetic radiation 406 in a second range of wavelengths. This radiation 406 may be detected by a detector 408. The detector 408 may be a device such as a charge coupled device (“CCD”) connected to a microscope, where the microscope may be oriented to allow detection of radiation 406 emitted by material 304 at the bottom of the trench 302, and to not receive or to filter out radiation emitted by fluorescent material in the rest of the first dielectric layer 104. The first dielectric layer 104 and the first conductor 102 may be held in place by a stage (not shown) that is capable of accurately positioning the first dielectric layer 104 and the first conductor 102 relative to the source 402 and detector 408. Such stages are known and available, for example, for SEM, e-beam exposure tools, wafer stepper/scanner stages, and interferometer applications.

In an embodiment, if the detector 408 detects an intensity of radiation 406 in the second range of wavelengths greater than a selected threshold intensity, the detection device 400 may determine that material 304 exists at the bottom of the trench 302, and that formation of the trench 302 has failed. In such a case, the first dielectric layer 104 may be further processed to remove the material 304, or may be discarded. In some embodiments, further processing to remove the material 304 may include one or more of a plasma etch, a reactive ion etch, a wet chemical etch, a salt bath, a laser ablation, or another processing method. After such processing, the detection device 400 may be used again to ensure that the processing successfully removed the material 304.

In an embodiment, if the detector 408 detects less than the threshold intensity of radiation in the second range of wavelengths while radiation 404 from the source 402 is directed at the trench, this may mean that substantially no material 304 is at the bottom of the trench 302. Thus, further processing may be performed to form the via 110, the second conductor 108, and the rest of the substrate 100.

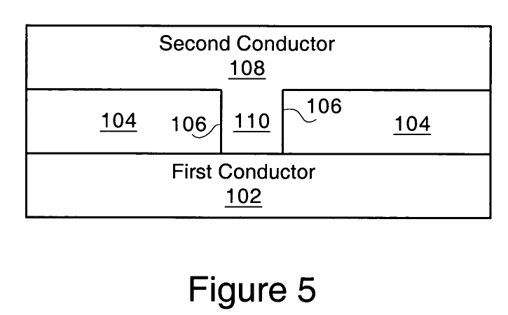

FIG. 5 is a side cross sectional view that illustrates the second conductor 108 and via 110 that may be formed on the first dielectric layer 104 and the first conductor 102 after the detector 408 detects less than the threshold intensity of radiation in the second range of wavelengths. In an embodiment, a conductive material such as aluminum or copper may be electroplated on the first dielectric layer 104 and the first conductor 102. In such an embodiment, the second conductor 108 and via 110 may be different areas of a single contiguous piece of material, rather than separate, discrete structures. The rest of the substrate 100 may then be formed, to result in the substrate 100 illustrated and discussed in FIG. 1.

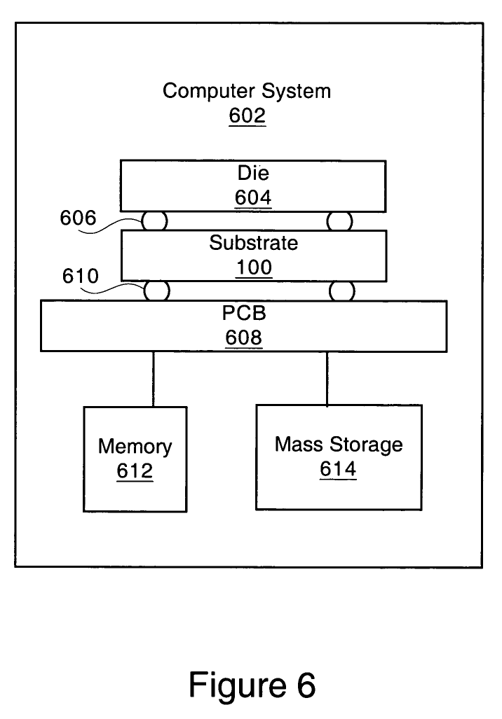

FIG. 6 is a schematic diagram of a computer system 602 according to one embodiment of the present invention. The computer system 602 may include the substrate 100 described above. A die 604 may be connected to the substrate 100 by connectors such as solder balls 606 or other connectors. The substrate 100 may be connected to a structure such as a printed circuit board (“PCB”) 608 by connectors such as solder balls 610 or other connectors. Additionally, the computer system 602 may include a memory 604 and/or a mass storage unit 614, which may be connected to the PCB 608. The memory 604 may be any memory, such as random access memory, read only memory, or other memories. The mass storage unit 614 may be a hard disk drive or other mass storage device. The computer system 602 may also include other components such as input/output units, a microprocessor, or other components.

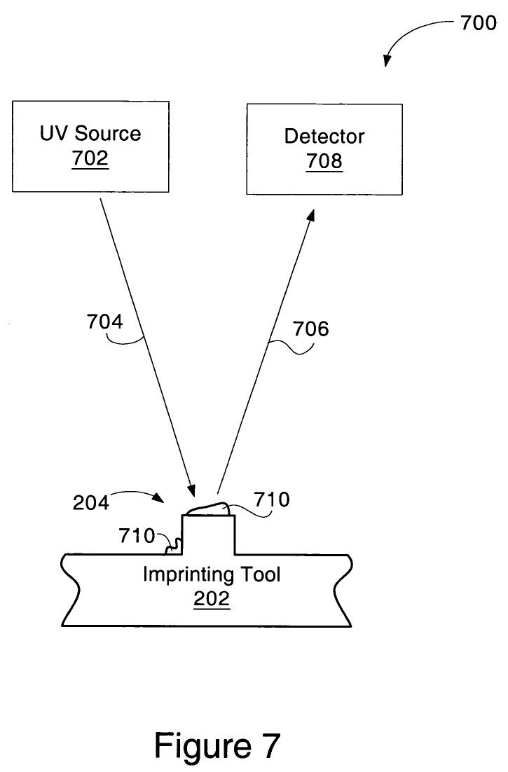

FIG. 7 is a schematic view of an embodiment of a detection device 700 for detecting whether there is material 710 from the first dielectric layer 104 stuck on the imprinting tool 202. The imprinting tool 202 may be tested by the device 700 after the tool 202 has imprinted a pattern on the first dielectric layer 104 a number of times. Material 710 from the first dielectric layer 104 may stick to the imprinting tool 202 as the tool 202 imprints the dielectric 104. The detection device 700 is similar to the detection device 400 described with respect to FIG. 4. A radiation source, such as UV source 702 may be used to generate radiation 704 which is directed at the imprinting tool 202. The radiation 704 may be in the first range of wavelengths that is absorbed by the fluorescent material in any material 710 from the first dielectric layer 104 stuck on the imprinting tool 202. In response, the fluorescent material within the material 710 may emit electromagnetic radiation 706 in a second range of wavelengths. This radiation 706 may be detected by a detector 708. The detector 708 may be a device such as a charge coupled device (“CCD”).

In an embodiment, if the detector 708 detects an intensity of radiation 706 in the second range of wavelengths greater than a selected threshold intensity, the detection device 700 may determine that material 710 from the first dielectric layer 104 has stuck to the imprinting tool 202. In such a case, maintenance (such as cleaning the tool 202) may be performed on the imprinting tool 202. In some embodiments, such maintenance or cleaning may include one or more of a plasma etch, a reactive ion etch, a wet chemical etch, a salt bath, a laser ablation, or another processing method. After such processing, the detection device 700 may be used again to ensure that the processing successfully removed the material 710.

In an embodiment, if the detector 708 detects less than the threshold intensity of radiation in the second range of wavelengths while radiation 704 from the source 702 is directed at the tool 202, this may mean that substantially no material 710 has stuck to the tool 202 and/or that no maintenance will be performed on the tool 202 at this time.

The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. The embodiments of a device or article described herein can be manufactured, used, or shipped in a number of positions and orientations. Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

1. A method, comprising:
applying a layer of a dielectric material comprising fluorescent material on a first substrate comprising a conductor;
forming, with an imprinting tool, at least one trench at least partially through the dielectric material to the first substrate;
directing radiation in a first range of wavelengths from a radiation source to the trench; and
detecting radiation in a second range of wavelengths emitted from dielectric material at the bottom of the trench.

2. The method of claim 1, wherein the fluorescent material comprises less than about 10 percent of the dielectric material.

3. The method of claim 1, wherein the fluorescent material comprises less than about 2 percent of the dielectric material.

4. The method of claim 1, wherein the first range of wavelengths comprises a range of ultraviolet radiation.

5. The method of claim 1, wherein the second range of wavelengths comprises a range of visible light.

6. The method of claim 1, further comprising determining that formation of the trench has failed in response to detecting an intensity of radiation in the second range of wavelengths emitted from dielectric material at the bottom of the trench in excess of a threshold intensity.

7. A method, comprising:
pressing an imprinting tool into a dielectric material comprising fluorescent material;
directing radiation in a first range of wavelengths from a radiation source to the imprinting tool; and
detecting radiation in a second range of wavelengths emitted from material on the imprinting tool.

8. The method of claim 7, wherein the first range of wavelengths comprises ultraviolet radiation.

9. The method of claim 7, wherein the second range of wavelengths comprises visible light.

10. The method of claim 7, further comprising maintaining the imprinting tool in response to detecting an intensity of radiation in the second range of wavelengths emitted from material on the imprinting tool in excess of a threshold intensity.

11. A device, comprising:
a first conductor;
a dielectric layer comprising fluorescent material on the first conductor, the dielectric layer having side walls that define boundaries of a trench through the dielectric layer;
a second conductor on the dielectric layer; and
conductive material that substantially fills the trench through the dielectric layer to form a via that electrically connects the first conductor and the second conductor.

12. The device of claim 11, wherein the fluorescent material comprises less than about 10 percent of the second dielectric layer.

13. The device of claim 11, wherein the fluorescent material comprises less than about 2 percent of the second dielectric layer.

14. The device of claim 11, wherein the dielectric layer has a thickness in a range of about 20 microns to about 50 microns.

15. The device of claim 11, wherein the dielectric layer, the first and second conductors, and the via comprise a substrate, and further comprising:
a die connected to the substrate;
a structural support connected to the substrate;
memory electrically coupled to the substrate; and
a mass storage unit.
